(19) United States
(12) Patent Application Publication
(10) Pub. No.: US 2014/0307565 A1
(43) Pub. Date: Oct. 16, 2014

(54) SYSTEMS AND METHODS FOR TV WHITE SPACE SPECTRUM SENSING

(71) Applicants: Vajira Samarasooriya, Ottawa (CA); Neil Birkett, Ottawa (CA); Michael Moher, Ottawa (CA); Jung Yee, Ottawa (CA)

(72) Inventors: Vajira Samarasooriya, Ottawa (CA); Neil Birkett, Ottawa (CA); Michael Moher, Ottawa (CA); Jung Yee, Ottawa (CA)

(73) Assignee: WI-LAN, INC., Ottawa, ON (CA)

(21) Appl. No.: 13/978,121

(22) PCT Filed: Jan. 6, 2012
(86) PCT No.: PCT/CA2012/050007

§ 371 Date: Oct. 28, 2013

Related U.S. Application Data
(60) Provisional application No. 61/430,845, filed on Jan. 7, 2011.

(51) Int. Cl. H04W 16/14; H04W 24/00

(52) U.S. Cl. CPC H04W 16/14; H04W 24/00
USPC 370/252

(57) ABSTRACT

A spectrum sensor detects the presence of incumbent signals in the television-band. The spectrum sensor can detect digital Advanced Television Systems Committee (ATSC) signals below a −114 dBm signal level and wireless microphone signals below a −110 dBm signal level with false detection rates less than 10%. A radio module receives radio-frequency signals and produces an intermediate-frequency signal reflecting signal received in a selected television channel. A baseband processor module receives the intermediate-frequency signal, digitizes it, and processes the digital data to detecting whether an incumbent signal is present in the selected channel. The processing may include using pilot detection based on power spectrum thresholding or statistic characteristic extraction to detect ATSC signals. The processing may also include using power spectrum thresholding or covariance based signal detection to detect wireless microphone signals.

### BACKGROUND

The present invention generally relates to the field of wireless communication systems and to systems and methods for sensing white space in the TV spectrum.

Various regulatory bodies exist in many countries to provide a centralized, tightly controlled allocation of radio spectrum resources for specific uses and, in most cases, to license rights to parts of the spectrum. For example, the Federal Communications Commission (FCC) is the regulatory body that mandates use of the spectrum in the United States and Canadian Radio-television Telecommunications Commission is its Canadian counterpart. These regulatory bodies allocate unused parts of the spectrum (which have never been licensed) or reallocate spectrum that becomes free, for example, as a result of technical changes. The frequency allocation plans mandate, in many cases, that specified parts of spectrum remain unused between allocated bands for technical reasons, such as avoiding interference.

Different countries use different standards for TV broadcasting as well as different allocation of the spectrum to the broadcast channels, different channel parameters, etc. For example, in the United States, digital TV broadcasters use the VHF (very-high frequency) spectrum and the lower part of the UHF (ultra-high frequency) spectrum between 54 MHz and 698 MHz.

Wireless microphones also transmit on frequencies in the UHF and VHF bands. Unfortunately, there are many different standards, frequency plans, and transmission technologies used by wireless microphones. For example, wireless microphones could use UHF and VHF frequencies, frequency modulation (FM), amplitude modulation (AM), or various digital modulation schemes. Some wireless microphone models operate on a single fixed frequency, but more advanced models operate on a user selectable frequency to avoid interference and allow use of several microphones at the same time.

There is a global trend to transition from analog TV to digital TV (DTV). DTV provides a better viewing experience and with personalized and interactive services while achieving a more efficient use of the spectrum. Conversion to DTV results in valuable bandwidth becoming free in the parts of the spectrum previously occupied by analog TV broadcasts. Each TV station broadcasting DTV signals in a certain geographic region (known as a TV market) will use a limited number of channels so that the spectrum not allocated to DTV broadcast in that region becomes free after transition to digital TV broadcast.

Migration for analog to digital TV opens the way to providing a variety of new wireless services. In the United States, the FCC mandated that all full-power television broadcasts will use the Advanced Television Systems Committee (ATSC) standards for DTV by the middle of 2009. In addition to the spectrum freed by the transition to digital TV, in each of the 210 TV markets in the US, many channels (for example, 15-40) are not used by TV broadcasting. These vacant channels are termed “white space.” Access to vacant spectrum facilitates a market for low-cost, high-capacity, wireless broadband networks, including indoor networks.

In order to efficiently use the white space, devices must be aware of what portions of the TV spectrum are unused. The devices may include circuitry, which may be referred to as “white space spectrum sensors,” or “white space sniffers,” or simply “sniffers,” to detect vacant channels. Detection of white space is difficult. The radio-frequency signals may have a very large range of possible signal strengths, for example, depending on the devices distance from a TV broadcast tower. Additionally, a weak signal in one channel may be difficult to distinguish from interference from an adjacent channel.

### SUMMARY

Systems and methods for TV white space spectrum sensing are provided. In one aspect, the invention provides a system for sensing TV-spectrum white space, the system including: a radio module arranged for receiving a radio-frequency signal and producing an intermediate-frequency signal according to the radio-frequency signal received in a selected television channel; and a baseband processor module coupled to the radio module and arranged for detecting the presence of an incumbent signal in the intermediate-frequency signal.

In another aspect, the invention provides a method for sensing an Advanced Television Systems Committee (ATSC) signal, the method including: receiving a radio frequency signal; digitizing a selected television channel from the received radio frequency signal to produce digital data; converting the digital data to frequency domain data; determining the maximum power in the frequency domain data at frequencies in a first window, the first window including frequencies near the pilot signal of an ATSC signal; determining the average power in the frequency domain data at frequencies in a second window, the second window excluding frequencies near the frequency having the maximum power in the first window; and detecting the presence of an ATSC signal based on the ratio of the maximum power in the frequency domain data at frequencies in the first window to the average power in the frequency domain data at frequencies in the second window.

In another aspect, the invention provides a method for sensing a wireless microphone signal, the method including: receiving a radio frequency signal; digitizing a selected television channel from the received radio frequency signal to produce digital data; converting the digital data to frequency domain data; smoothing the frequency domain data by averaging; estimating a noise level in the radio frequency signal using the smoothed frequency domain data; determining average powers for the smoothed frequency domain data in a plurality of frequency windows, the frequency windows having a same bandwidth with different starting frequencies; and detecting the presence of a wireless microphone signal based on the number of average powers greater than a threshold for consecutive starting frequencies, the threshold being based on the noise level.

Other features and advantages of the present invention should be apparent from the following description which illustrates, by way of example, aspects of the invention.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a functional block diagram of a spectrum sensor in accordance with aspects of the invention;

FIG. 2 is a functional block diagram of a radio module in accordance with aspects of the invention;

FIG. 3 is a functional block diagram of a baseband processor module in accordance with aspects of the invention;

FIG. 4 is an example of an Advanced Television Systems Committee transmission spectrum in accordance with aspects of the invention;

FIG. 5 is an example of an estimated power spectrum in accordance with aspects of the invention;

FIG. 6 is an example of an estimated power spectrum in accordance with aspects of the invention;

FIG. 7 is an example of wireless microphone signal detection for a spectrum sensor in accordance with aspects of the invention;

FIG. 8 is an example of Advanced Television Systems Committee signal detection for a spectrum sensor in accordance with aspects of the invention; and

FIG. 9 is a diagram of an access point with a spectrum sensor in accordance with aspects of the invention.

### DETAILED DESCRIPTION

The present disclosure describes systems, methods, algorithms, and designs for a white space spectrum sensor. Although specific embodiments are described for white space in the TV spectrum, the described systems, methods, algorithms, and designs are generally applicable to sensing radio frequency spectrum for unused frequencies. A device may then transmit in the unused frequencies. For the frequencies in the TV spectrum that range from 54 MHz to 698 MHz (channel 2 to 51), an implementation of the spectrum sensor can detect digital TV (DTV) signals at a −116 dBm signal level and wireless microphone (WM) signals at a −110 dBm signal level, with false detection rates less than 10%. These detection levels exceed FCC requirements.

With the transition from analog TV (NTSC) to digital TV (ATSC), the so called TV white space is now available for unlicensed wireless applications. Unlicensed devices that use the frequency band, called TV band devices (TVBDs), must not interfere with licensed communication services (incumbent services), which include analog TV receivers, DTV receivers, and wireless microphones. This requires a TVBD to not transmit when it is within the allowed coverage area of an ongoing incumbent service. Two major methods to achieve protection of incumbent services are TVBD location based database query (i.e., geo-location and database service) and spectrum sensing. In the 2008 ruling of FCC (FCC 08-260), both methods are required for a TVBD to pass FCC certification. However, according to a 2010 FCC ruling (FCC 10-174, Second Memorandum Opinion and Order in the Matter of Unlicensed Operation in the TV Broadcast Bands), a TVBD can rely solely on the database query method or can rely solely on spectrum sensing for protection of incumbent services. A motivation for this change, as specified in the 2010 FCC ruling, is that none of the spectrum sensing devices sent for FCC testing could achieve the sensitivity requirement set by the FCC.

Spectrum sensing, compared to database query, has simplicity among its advantages. It does not require Internet access to a database service. This may be particularly advantageous in areas where Internet access is not always available. Spectrum sensing also simplifies TVBDs for service connectivity applications, such as video streaming or direct connection, where Internet access may not otherwise be required. Moreover, unregistered incumbent signals above the sensitivity level of a spectrum sensor can be detected and protected by a TVBD with spectrum sensing. In comparison, database query cannot protect any licensed user not registered with the database and only protects licensed users registered with the database. Obtaining accurate location information for a TVBD may be difficult under certain conditions, e.g., when GPS signals are weak or impaired, such as inside a building. Either enhanced or assisted geo-location systems may be needed, which could introduce excessive cost.

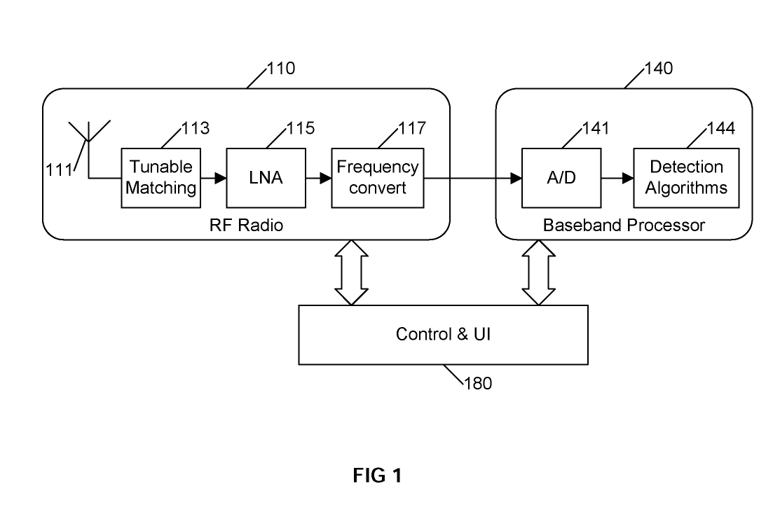

FIG. 1 is a functional block diagram of a spectrum sensor. The spectrum sensor detects incumbent signals in the TV white space (TVWS) frequency range from 54-698 MHz. The maximum received signal power for the sensor may be 15 dBm in 6 MHz bandwidth. The minimum received signal level for the sensor may be −114 dBm. Furthermore, the sensor may have a signal input range of 129 dB, with detection dynamic range of 180 dB. The spectrum sensor is designed for low hardware cost and complexity and, for example, may detect ATSC signals using pilot detection based on power spectrum thresholding and statistic characteristic extraction and detect WM signals using power spectrum thresholding and covariance based signal detection. The spectrum sensor, in an embodiment, can detect of NTSC/ATSC signals at −114 dBm sensitivity with 90% confidence (less than 10% error) even in the presence of adjacent channel interference at −53 dBm.

The spectrum sensor includes of a radio module 110, a baseband processor module 140, and a control and user interface (CUI) module 180. The radio module 110 receives TV band signal at an antenna 111. A tunable matching network module 113 provides channel selectivity. The received signal in the selected channel is amplified by a low noise amplifier 115. The amplified signal is downconverted in a frequency converter module 117 to produce an intermediate frequency signal.

The baseband processor module 140 receives the intermediate frequency signal from the radio module 110. An analog-to-digital converter 141 samples the intermediate frequency signal to produce digital signals for further processing in the digital domain. A detection algorithm module 144 processes the digital signals to detect various types of wireless signals. In one embodiment, the baseband processor module 140 may, for example, provide detection data after detecting ATSC or WM signals.

The CUI module 180 provides a control and status interface between the spectrum sensor and other parts of a TVBD. In an embodiment, the CUI module 180 also accepts detection data from the baseband processor module 140 and makes decisions based upon analysis from the decision data.

When the spectrum sensor receives weak signals, for example, an ATSC signal at −114 dBm, the signal-to-noise ratio may be as low as about −15 dB. The spectrum sensor still detects incumbent signals. For example, the spectrum sensor may utilize the pilot tone contained in an ATSC signal, which is 17 dB higher than the average level, to detect a weak ATSC incumbent signal. Additionally, the baseband processor module 140 may use super frequency resolution processing (e.g., with multi-stage sampling rate conversion) to detect the presence the pilot tone and avoid interference from adjacent channels. The spectrum sensor also provides a short decision time so that it may scan, for example, channels 21-51 in 30 seconds.

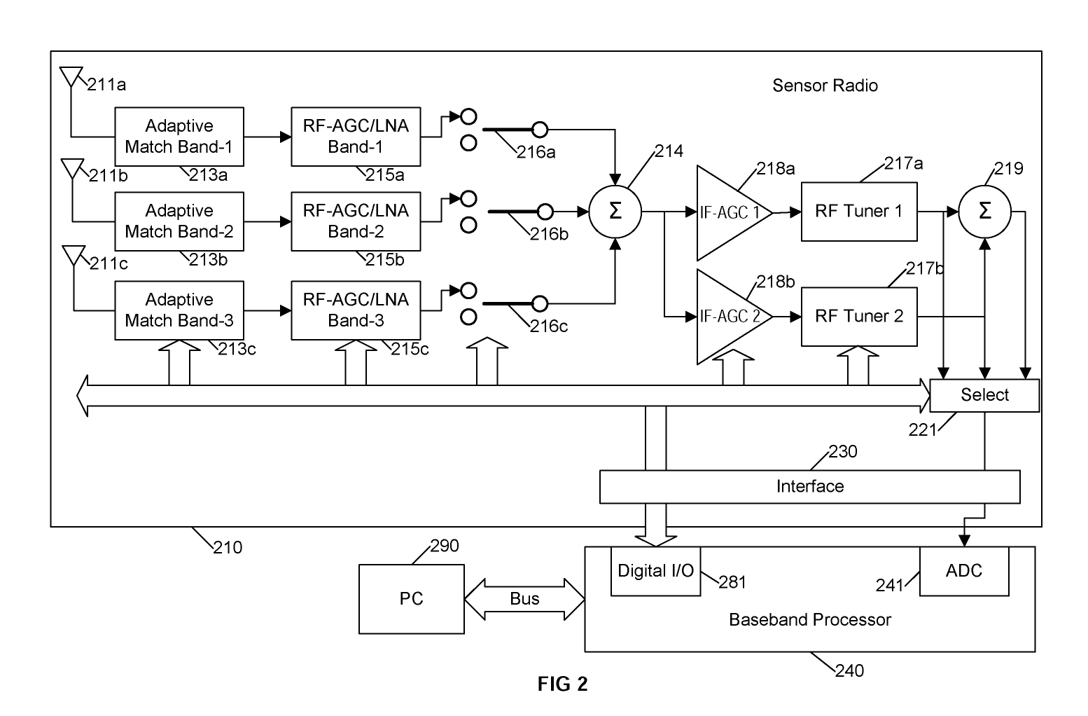

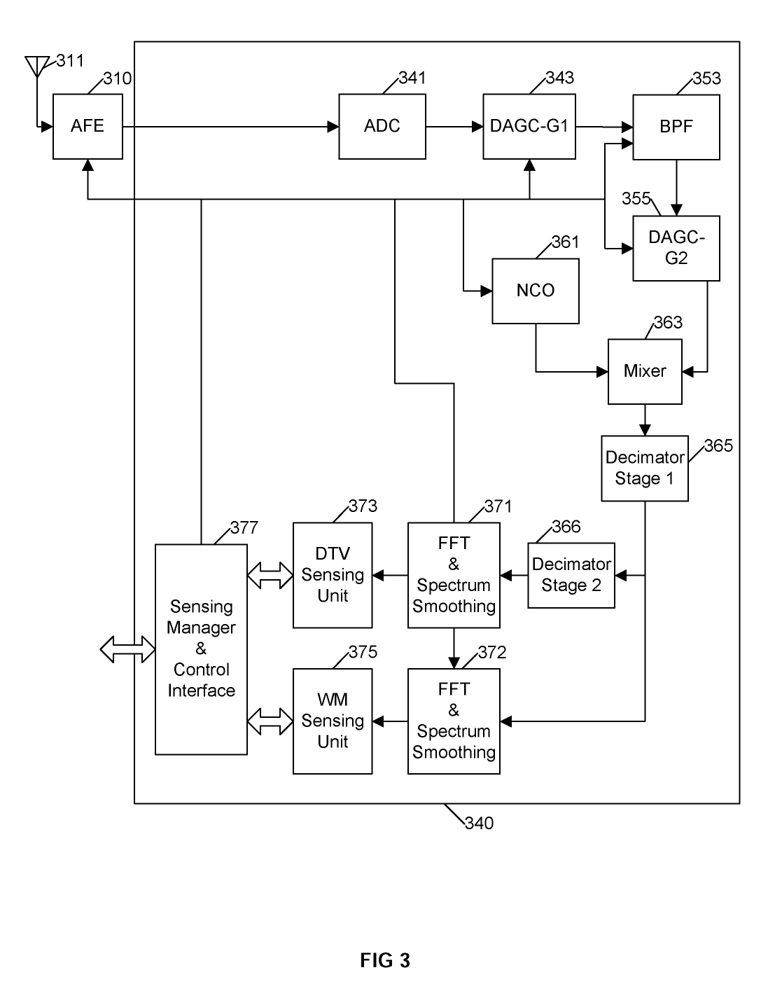

FIG. 2 and FIG. 3 are functional block diagrams of a spectrum sensor. FIG. 2 illustrates details of a radio module 210; FIG. 3 illustrates details of a baseband processor module 340.

In the embodiment of FIG. 2, the radio module 210 includes three radio frequency (RF) tunable matching networks 213 to receive signals from three antennas 211. The matching networks 213 may have overlapping frequency ranges. The frequency ranges, in an embodiment, are 44-170 MHz, 154-454 MHz, and 400-863 MHz. The signals from the matching networks 213 are amplified by low noise amplifiers (LNAs) 215. The LNAs 215 may include RF automatic gain control (AGC). The dynamic range for the RF AGC is 40 dB in an embodiment.

An RF combining network receives the amplified signals from the LNAs 215. The RF combining network includes a summing circuit 214 that sums three input signals. Each of the input signals is selected by one of three switches 216. The switches 216 are operated to supply the amplified signal from the corresponding one of the LNAs 215 or a zero signal to the summing circuit 214. When the radio module 210 is being operated to detect an incumbent signal in a single channel, two of the switches 216 supply a zero or null signal to the summing circuit 214 and a third one of the switches 216 supplies the amplified signal from the one of the LNAs 215 that supplies the signal in the channel being operated on. The RF combining network also allows concurrent detection of incumbent signals on multiple channels. For example, the signal from a first channel may be supplied to the summing circuit 214 via the first switch 216a, the first LNA 216a, the first tunable matching network 213a, and the first antenna 211a while the signal from a second channel is supplied to the summing circuit 214 via the second switch 216b, the second LNA 216b, the second tunable matching network 213b, and the second antenna 211b. Such an operation may be used to concurrently analyze signals in channels that are not contiguous. Operation on multiple channels concurrently may be termed channel bonding.

An intermediate frequency network converts the signal from the summing circuit 214 to an intermediate frequency (IF) with, for example, a center frequency of 20 MHz and a bandwidth of 6 MHz. The IF network includes two IF AGC modules 218 to adjust signal levels. The IF AGC modules 218 have, in an embodiment, a dynamic range of 56 dB. Each IF AGC module supplies a signal to one of two IF tuner modules 217. The IF tuner modules 217 provide, in an embodiment, 60 dB attenuation in the stopband and a width of approximately 1 MHz in the transition band of the bandpass filtering provided by the module. The IF signal is sent to the baseband processor for detection processing. A selector module 221 selects the signal from the first IF tuner module 217a, the signal from the second IF tuner module 217b, or the sum of the two IF signals from a summer circuit 219 to send to the baseband processor. The summer circuit 219 may be operated in conjunction with the RF combining network to supply a signal to an IF signal that combines signal from two TV channels.

The radio module 210 may include an interface circuit module 230 to couple signals between the radio module 210 and the baseband processor module 240. The interface circuit module 230 may provide, for example, level translation or DC isolation. Additionally, in the embodiment of FIG. 2, a bus couples the baseband processor module 240 to a personal computer 290. In other embodiments, the baseband processor module 240 may be coupled, for example, to a spectrum manager in a TVBD.

As shown in FIG. 3, the baseband processor module 340 accepts the IF signal from the radio module 210. The radio module may also be termed an “analog front end” or “AFE.” The baseband processor module 340 may be implemented, for example, using an Xtreme DSP processing kit. For another example, the baseband processor module 340 may be implemented in an integrated circuit.

The baseband processor module 340 samples the IF signal in an analog-to-digital converter 341. The analog-to-digital converter 341 may, for example, operate at a 105 MHz sampling frequency with 14-bit or 16-bit accuracy. Two digital AGC modules (first DAGC module 343 and second DAGC module 355) bring the sampled digital sequence to an appropriate magnitude level to effectively utilize the dynamic range while avoiding clipping in subsequent processing. A bandpass filtering module 353 further attenuates interference that may occur from adjacent channels. The bandpass filtering module 353, in an embodiment, has 40 dB attenuation in the stopband and the transition band has a bandwidth of 2.5 MHz. The filtered signal is then mixed in a mixer module 363 with a signal from a numerically controlled oscillator (NCO) 361 to convert to a low-IF band. The signal from the numerically controlled oscillator 361 may be a complex-valued signal. Accordingly, the signals from the mixer module 363 and subsequent modules are also complex valued. In an embodiment, the low-IF band signal may have a center frequency of 5.381 MHz (half of the ATSC symbol rate). In another embodiment, the numerically controlled oscillator 361 and mixer module 363 operate to produce the low-IF band signal such that an ATSC pilot signal is shifted to zero frequency. For example, when the IF signal received by the baseband processor module 340 has a center frequency of 20 MHz and the pilot signal frequency is 17.309441 MHz (20 MHz minus one-half the 6 MHz bandwidth of the ATSC signal plus the 309,441 kHz ATSC pilot signal frequency). Accordingly, an NCO signal frequency of 17.309441 MHz may be supplied to the mixer. The use of complex-valued signals allows the positive and negative signal frequencies to be distinguished.

The low-IF band signal is downsampled in a first decimator module 365. The signal from the first decimator module 365 is again downsampled in a second decimator module 366. In an embodiment, the first decimator module 365 downsamples by a factor of 5 and the second decimator module 366 downsamples by a factor of 256. The signals from the first decimator module 365 and the second decimator module 366 are then FFT converted to the frequency domain in a first FFT module 372 and a second FFT module 371, respectively. The FFT modules may additionally apply spectrum smoothing filters. The frequency domain data are processed for detection of incumbent services. A DTV sensing module 373 processes the frequency domain data from the second FFT module 371 to detect DTV signals. A WM sensing module 375 processes the frequency domain data from the first FFT module 372 to detect WM signals. The Fourier transform sizes used in the two FFT modules may be different and may be selected according the particular processing of the DTV sensing module 373 and the WM sensing module 375. A management and control interface module 377 manages operations of the baseband processor module 340, for example, by supplying control signals to other modules.

Many variations in the radio module 210 and the baseband processor module 340 of the spectrum sensor illustrated in FIGS. 2 and 3 may be made. For example, the number of RF paths and the number of IF paths in the radio module 210 may be altered. Additionally, some modules may be omitted, for example, when a single RF path or a single IF path is included, the associated combining network or selector module may not be needed. For another example, the radio module 210 may supply two IF signals to the baseband processor module 340 which may correspondingly include two analog-to-digital converters. Samples from a second analog-to-digital converter could be used, for example, to detect interfering signals present in channels adjacent to the channel corresponding to the samples from a first analog-to-digital converter. For a further example, the baseband processor module 340 could have a single decimation module and accordingly a single FFT module.

The RF AGC 215, IF AGC 218, and high accuracy of the ADC 341, in an exemplary embodiment, give the spectrum sensor a dynamic range of 180 dB. The corresponding input signal range is 129 dB (15 dBm to −114 dBm).

A TVBD can transmit in the TVWS ranging from 54 MHz to 698 MHz if its transmission does not interfere with incumbent services. To protect incumbent services, a TVBD may use geo-location to locate itself and query an incumbent database service to find out if its transmission on a certain channel would cause interference to incumbent services. Alternatively or additionally, a TVBD may use spectrum sensing to detect the presence of incumbent services.

The maximum expected received signal power is 15 dBm in a 6 MHz bandwidth. This corresponds to the condition that a 100-kW ATSC transmitter is 100 m away and transmits at 54 MHz (channel 2), assuming a mean path loss exponent of 2.76. The minimum expected received signal level is −114 dBm, corresponding to the condition that the 100-kW transmitter is 80 km away, transmits at 698 MHz (channel 51) with shadowing of 8 dB, and the mean path loss exponent is 2.76.

In Section 15.717 of the 2010 FCC ruling (FCC 10-174), a TVBD that relies on spectrum sensing is limited to a maximum EIRP of 50 mW, and it does not require geo-location and database access. The 2010 FCC ruling also stated that the detection threshold for ATSC signals is −114 dBm, averaged over a 6 MHz bandwidth. The detection threshold for analog TV signals is −114 dBm, averaged over a 100 kHz bandwidth. The threshold for low power auxiliary signals or low power auxiliary stations, including wireless microphone signals, is −107 dBm, averaged over a 200 kHz bandwidth. These thresholds are referenced to an omnidirectional receive antenna with a gain of 0 dBi.

Furthermore, with the thermal noise power or thermal noise floor for a 6 MHz ATSC channel at about −106 dBm, the above detection thresholds may require reliable detection of signal levels lower than the noise floor. Moreover, when a strong signal is present on an adjacent channel, the adjacent channel interference from that signal makes the detection even more difficult. The operating conditions may also assume a single adjacent channel interferer.

The FCC requires a TVBD to sense a channel for a minimum of 30 seconds without detection of incumbent signals before its operation starts. The TVBD needs to perform in-service monitoring of an operating channel at least once every 60 seconds. If an incumbent signal is detected, the TVBD must cease transmission within 2 seconds.

The spectrum sensors of FIGS. 1, 2, and 3 may detect incumbent signals in the received signals using processes that operate according to various algorithms. For example, the detection algorithm module 144 of FIG. 1 and the DTV sensing module 373 and the WM sensing module 375 of FIG. 3 may use digital signal processors to detect incumbent signals. Processes for detection of ATSC signals include pilot detection based on power spectrum thresholding, peak pilot to mean noise ratio, and pilot magnitude statistics extraction. Processes for detection of WM signals include power spectrum thresholding and covariance based signal detection. The described processes for detection of incumbent signals are by way of example, and other processes or variations of the described processes may also be used. For detection of incumbent ATSC signals, the frequency domain data received by the DTV sensing module 373 arrives via a processing path that includes the mixer module 363, the first decimator module 365, the second decimator module 366, and the second FFT module 371. For detection of incumbent WM signals, the frequency domain data received by the WM sensing module 375 arrives via a processing path that includes the mixer module 363, the first decimator module 365, and the first FFT module 372.

A TVWS spectrum sensing device may sense and detect different types of signals. For example, in North America, the spectrum sensing operates to find out if ATSC or wireless microphone signals are present in a particular TV channel. In other parts of the world, the spectrum sensing may operate to detect the presence of other types of signals, such as DVB-T, DVB-T2 in Europe, ISDB-T in Japan, and NTSC in Canada.

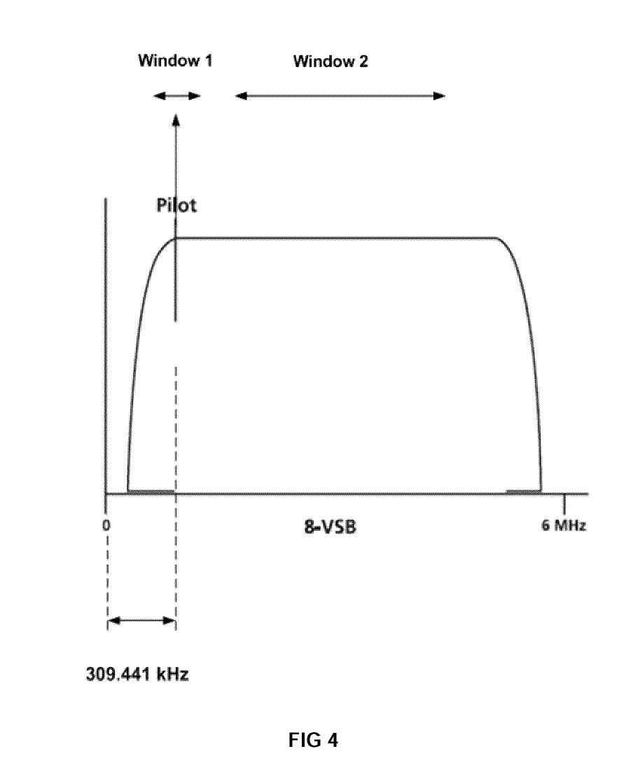

A process of ATSC pilot detection based on power spectrum thresholding may be used to detect incumbent ATSC signals. The process detects the pilot signals in ATSC signals in the power spectrum. FIG. 4 shows the transmission spectrum of an example ATSC signal. The ATSC signal has a bandwidth of 6 MHz. Shown in FIG. 4 is a single frequency pilot, which has a power level about 17 dB higher than the average ATSC signal level, although the power of the pilot signal is 11.62 dB below the power of the total transmitted ATSC signal. The fixed frequency location and relatively high power level make it easy to detect the pilot even at very low signal-to-noise ratio (SNR). In comparison, a WM signal may be a 200 kHz narrowband signal. Its center frequency can change in 25 kHz steps within the bandwidth of a TV channel. A WM signal is generally frequency modulated, with a typical transmission power of 10 mW or less.

To obtain the power spectrum for an ATSC channel, an input on a specific TV channel is used. Signals on other channels can be attenuated by bandpass filtering. After analog-to-digital conversion, time domain samples are grouped into vectors of length 2^{k}, where k is an integer. Each vector is then Fast Fourier Transformed (FFT) into the frequency domain. Averaging over multiple vectors provides a power spectrum estimate for the channel. The averaging procedure reduces fluctuation of noise and signal in the power spectrum over time.

In order to better track changes in the power spectrum, exponential averaging can be used. Specifically, taking the latest FFT output vector to be Pₗ, and the average using the previous FFT output vectors to be P̅ᵢ̅₋̅₁̅, then the updated averaging result is:

P̅ₗ̅=α P̅ₗ̅₋̅₁̅+(1−α)Pₗ,

where αε(0,1) is the forgetting factor.

Take the averaged power spectrum estimate after l averages to be P̅ₗ̅=[pₗ¹pₗ² . . . pₗ^{N}], where N is the FFT size, and pₗⁱ are the estimated power levels at discrete frequencies. Example FFT sizes include 1024, 4096, or 32768 for ATSC sensing and 4096 for WM sensing. To estimate the power level of the pilot, a narrow band window is placed around the pilot frequency (Window 1 in FIG. 4). Window 1 corresponds to the elements in P̅ᵢ̅ from index n₁ to n₂. The window should be large enough to cover all expected frequency offset caused by local oscillator mismatch and channel effects. The maximum power level in Window 1 is then used as the power level for the pilot (denoted as Pₗ), i.e.,

$${P}_{l} = {max}_{{n}_{1} \leq n \leq {n}_{2}} {P}_{l}^{n}$$

To estimate the noise and signal level in the other regions of the channel, another window is used (Window 2 in FIG. 4). Window 2 corresponds to index n₃ to n₄ in P̅ₗ̅. Window 2 is chosen in the frequency region where the signal power level is relatively constant for ATSC. Note that when there is no ATSC signal present, Window 2 contains white noise which has a flat power level. To avoid narrow band noise or deep fading and improve the accuracy of the estimation, frequencies on which the power levels are too high or too low are not used in the averaging calculation. Two power level values P_{W}_{₂}^{min} and P_{W}_{₂}^{max} are used for thresholding purposes, they are determined in such a way that the remaining frequencies occupy a certain percentage of the Window 2 bandwidth. The percentage may be, for example, 80%. The power levels on the remaining frequencies are then averaged as:

P₂=avg(pₗ^{j}),jε[n₃n₄] and pₗ^{j}ε[p_{W}_{₂}^{min},p_{W}_{₂}^{max}]

ATSC signal presence can be detected using the following decision rule:

$$\{ \begin{matrix}\frac{{P}_{1}}{{P}_{2}} \geq r ⇒ ATSC signal detected , \\ \frac{{P}_{1}}{{P}_{2}} < r ⇒ ATSC signal not present\end{matrix} .$$

Here, r is the pre-determined decision threshold. The choice of r is closely related to the probability of detection and false alarm rate.

Energy detection can also be used to detect the ATSC pilot signal, with appropriate determination of the noise and interference floor in the channel, which may be similar to what has been discussed just above. Referring to FIG. 4, the power spectrum of a channel may be obtained from performing an FFT on the sampled baseband signal. Two preset windows (Window 1 and Window 2) are used to determine signal levels. Window 1 is a narrow window which is expected to contain the ATSC pilot. Window 2 is a wide window in the relatively flat region of the ATSC signal. With appropriate processing of the two windows, a detection decision can be made about the presence of an ATSC signal.

A process of ATSC pilot detection based on magnitude statistics extraction may also be used to detect incumbent ATSC signals. The process is also based on pilot detection. Magnitude information for a small number of frequencies at or near the pilot frequency is first extracted. Then the magnitude statistical distribution is obtained. Significant differences are observed in the distribution characteristics for the two cases where the ATSC signal is present or not present. The differences are exploited to detect the ATSC signal.

Since magnitude information is extracted on only a small number of frequencies, the process can use efficient methods such as the Goertzel algorithm instead of the FFT. The Goertzel algorithm can compute a specific frequency component (DFT bin) of a complex sequence of length N, for a total of 2N+4 multiplications and 4N+4 additions/subtractions. In comparison, the FFT requires N log₂ N multiplications and 3N log₂ N additions/subtractions for all N DFT bins. As a result, to calculate a small number of DFT bins, the Goertzel algorithm is more computationally efficient than the FFT. Additionally, the Goertzel algorithm can compute as samples come in, while the FFT needs all the N complex values to be available before the computation begins.

A process of ATSC signal detection based on peak pilot to mean noise ratio may also be used to detect incumbent ATSC signals. In this process, the pilot signal frequency is shifted to baseband and downsampled before conversion to the frequency domain. For example, the frequency of the pilot signal may be nominally zero and the sampling frequency may be about 82 kHz (a 105 MHz analog-to-digital converter frequency downsampled by 1280). Accordingly, the frequency domain data may correspond to window 1 in FIG. 4 with a bandwidth of 82 kHz centered at zero.

A peak search is performed in a narrow window about zero frequency to detect the pilot signal. Although the pilot signal frequency is nominally zero, inaccuracies of frequencies in the analog front end may cause a frequency offset of the pilot signal. An example window width is 5 kHz. The peak search is performed on a power spectrum estimate that has been averaged as described above. The averaged power spectrum estimate after l averages may be written P̅ₗ̅=[pₗ¹pₗ² . . . p₁^{N}], where N is the FFT size, and pₗⁱ are the power levels at discrete frequencies. The peak is then found as Pₚₑₐₖ=max(pₗ^{j}), n₁≦j≦n₂, with nₚₑₐₖ being the peak frequency bin. The limits on the peak search, n₁ and n₂ are the frequency bin indices of the narrow window about zero frequency.

A mean power spectrum level of the noise floor around the peak is then found. A small number of frequency bins about the peak are excluded from the mean. The mean is then found as P₂=avg(pₗ^{j}), for j from 1 to n₃ and from n₄ to N, where n₃=nₚₑₐₖ−K n₄=nₚₑₐₖ+K with K controlling the number of frequency bins excluded. In an embodiment, K=3.

ATSC signal presence can be detected using the following decision rule:

$$\{ \begin{matrix}\frac{{P}_{1}}{{P}_{2}} \geq r ⇒ ATSC signal detected , \\ \frac{{P}_{1}}{{P}_{2}} < r ⇒ ATSC signal not present\end{matrix} .$$

In the decision rule, r is the decision threshold.

A process of WM detection based on power spectrum thresholding may be used to detect incumbent WM signals. Wireless microphones transmit frequency modulated signals at low power levels. A WM signal is typically a narrow band signal with less than 200 kHz bandwidth. However, unlike the ATSC pilot which is located at a known frequency, the carrier frequency of a WM signal can be located anywhere in a TV channel and is generally unknown. Although a WM signal may have designated bandwidth of 200 kHz, the occupied bandwidth of a WM signal will often be much less than 200 kHz. In a frequency modulated WM signal, the occupied bandwidth depends on the level of the modulating signal with a loud speaker causing a larger bandwidth and a soft speaker causing a smaller bandwidth.

The concentration of transmitted power in such a narrow band suggests that the signal can be detected in the power spectrum. Similar to the power spectrum thresholding method described above for ATSC signals, an input signal on a specific TV channel is sampled and FFT transformed to the frequency domain. Exponential averaging over multiple FFT output vectors then provides a power spectrum estimate for the channel. Take the output vector of the exponential averaging to be P̅ₗ̅=[pₗ¹pₗ² . . . pₗ^{N}], where N is the FFT size, and Pₗⁱ s are the averaged power levels at discrete frequencies which are determined by the sampling frequency and the FFT size N.

The process detects a relatively high power frequency band with a bandwidth similar to that of a typical WM signal. To achieve this, the process first estimates the noise power level in the channel. The noise commonly has a relatively flat power level over a majority part of the channel, thus the process partitions the power level range in the channel into narrow power levels and finds the narrow power range which covers the largest number of discrete frequencies as the noise power level. Specifically, let nₘᵢₙ and nₘₐₓ denote, respectively, the minimum and maximum indices covering the frequency range for any WM that could transmit in the channel. In this frequency range, the minimum and maximum power levels can be found as Pₘᵢₙ and Pₘₐₓ, respectively. The power range between Pₘᵢₙ and Pₘₐₓ can be separated into K levels:

$${V}_{k} = {P}_{m i n} + ( k - 1 ) \frac{( {P}_{ma x} - {P}_{m i n} )}{K} , k = 1 , … , K .$$

Let mₖ denote the number of power spectrum values Pₗⁱ(iε[nₘᵢₙ,nₘₐₓ]) with Pₗⁱε[Vₖ,Vₖ₊₁]. Then the noise power level can be estimated as:

$${N}_{0} = \frac{{V}_{{M}_{ma x}} + {V}_{{M}_{ma x} + 1}}{2} ,$$

where τm⊥k, k=1, K−1.

The power threshold P_{thrld} is then determined as

P_{thrld}=N₀+δ,

where δ is a constant.

To detect the WM signal, a frequency window which is smaller than the typical WM bandwidth is used. For example, to detect a WM signal with a 200 kHz bandwidth, a frequency window of 30 kHz may be used. sliding the window across the average output P̅ₗ̅ and obtain the average power within the window results in an average power vector:

P̅_{l,avg}=[p_{l,avg}¹p_{l,avg}² . . . p_{l,avg}^{N-N}^{_{w}}],

where N_{w} is the size of the sliding window, and P_{l,avg}ⁱ=(pₗⁱ+ . . . +pₗ^{i+N}^{_{w}}⁻¹)/N_{w} is the average power in the sliding window.

The detection of WM is then declared if there is a frequency region with at least S_{thrld} consecutive indices with average power level exceeding the power threshold P_{thrld}, i.e.,

WM signal detected, if there exists index j such that

p⊥(l,avg)τP⊥thrld∀iε[j,j+N⊥w−1];

WM signal not present, otherwise.

A variation of the above process of WM detection based on power spectrum thresholding is now described. The process detects the presence or absence of a WM signal, in the TV channel being analyzed, by searching for narrow-band signal energy that is similar to that expected for a WM signal.

In an example implementation of the process, the power spectrum estimate for the channel is from a 21 MHz sample rate (105 MHz analog-to-digital sampling rate downsampled by 5) and an FFT size of 4096. This results in FFT bins spaced by 5.127 kHz (21 MHz/4096). A sliding window of 6 FFT bins is used resulting in a 30.76 kHz window width.

The sliding window is shifted across the FFT bins and the process calculates the power in the window at each position. The positions of the sliding window may be shifted by 1 or more FFT bins. For M sliding window positions (where M is a bounded by the FFT size minus the sliding window width), let the p_{SL}ⁱ designate the total power in the window at position i for i=1, . . . , M.

The process then calculates an estimated noise power at each sliding window position. In one embodiment, the estimated noise power in each FFT bin N₀ is determined as described above using the mode of the energy values. The total noise power at each sliding window is N_{SL}ⁱ=N₀×N_{W}, where N_{W} is the width of the sliding window. In other embodiments, the total noise power at each sliding window may vary for different sliding window positions.

The process makes a preliminary decision for each sliding window position as:

$${d}_{i} = \{ \begin{matrix}1 , if \frac{{P}_{SL}^{i}}{{N}_{SL}^{i}} > δ \\ 0 , otherwise\end{matrix}$$

where δ is a constant, for example 2.

The process applies heuristics to the preliminary decisions to determine whether narrowband energy clusters are present indicating the detection of an incumbent WM signal. An example heuristic looks for series of L (for example, 3) consecutive ones in the preliminary decisions dᵢ. When L or more consecutive ones are found, the process determines that a WM signal is detected. In an embodiment, the process disregards series of consecutive ones wider than L₂ (for example, 6). That is, the process determines that a WM signal is detected when the number of consecutive ones is between L and L₂. The process disregards series of consecutive ones less than L as this may represent interfering tones.

A process of WM detection based on covariance based signal detection may be used to detect incumbent wm signals. The process explores the different statistical characteristics of a WM signal and noise. The difference comes from the fact that the WM signal is a narrow band signal, while thermal noise and adjacent channel interference are wideband signals with statistical characteristics determined by the receiver filtering and signal processing procedure.

Take the sampled WM signal to be s(n) and the sampled noise to be η(n), where n=1, 2, . . . is the sample index. The sampled sequence can be written as:

$$x ( n ) = \{ \begin{matrix}s ( n ) + η ( n ) , if WM signal present , \\ η ( n ) , otherwise\end{matrix}$$

For a sequence of L consecutive samples, the covariance matrices for the received signal, WM signal and noise can be expressed as:

Rₓ=E{[x(n)x(n−1) . . . x(n−L+1)]^{H}[x(n)x(n−1) . . . x(n−L+1)]},

Rₛ=E{[s(n)s(n−1) . . . s(n−L+1)]^{H}[s(n)s(n−1) . . . s(n−L+1)]},

R_{η}=E{[η(n)η(n−1) . . . η(n−L+1)]^{H}[η(n)η(n−1) . . . η(n−L+1)]}.

With R_{η} obtained in advance, the process can decompose R_{η} as R_{η}=σ_{η}²Q², where σ_{η}² is the noise variance and Q is a positive definite Hermitian matrix.

Next the process uses Q to whiten the noise, and transform the covariance matrix Rₓ as

$${R}_{x}^{′} = {Q}^{- 1} {R}_{x} {Q}^{- 1} = \{ \begin{matrix}{R}_{S}^{′} + {σ}_{η}^{2} I , if WM signal present , \\ {σ}_{η}^{2} I , otherwise\end{matrix} .$$

Here, Rₛ′=Q⁻¹RₛQ⁻¹, and I is an identity matrix.

Since the WM signal samples are correlated, Rₛ′ is generally not a diagonal matrix. In other words, some of the off-diagonal elements of Rₛ′ are not zero. This feature can be used to detect WM signals. For example, the method can compare the sum of all covariance matrix values to the sum of the covariance matrix diagonal values and use the following decision rule:

$$\{ \begin{matrix}\frac{{T}_{1}}{{T}_{2}} \geq γ ⇒ WM signal detected , \\ \frac{{T}_{1}}{{T}_{2}} < γ ⇒ WM signal not present\end{matrix} ; \\ where {T}_{1} = {\sum }_{n = 1}^{L} {\sum }_{m = 1}^{L} \vert {r}_{n m} \vert , {T}_{2} = {\sum }_{n = 1}^{L} \vert {r}_{nn} \vert ,$$

with Rₓ′={rₙₘ}, and γ is a pre-determined threshold.

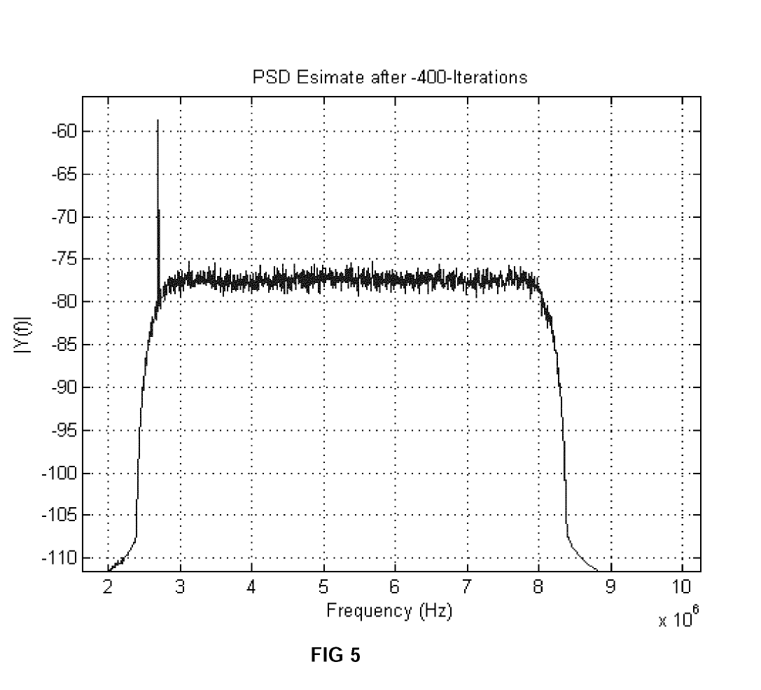

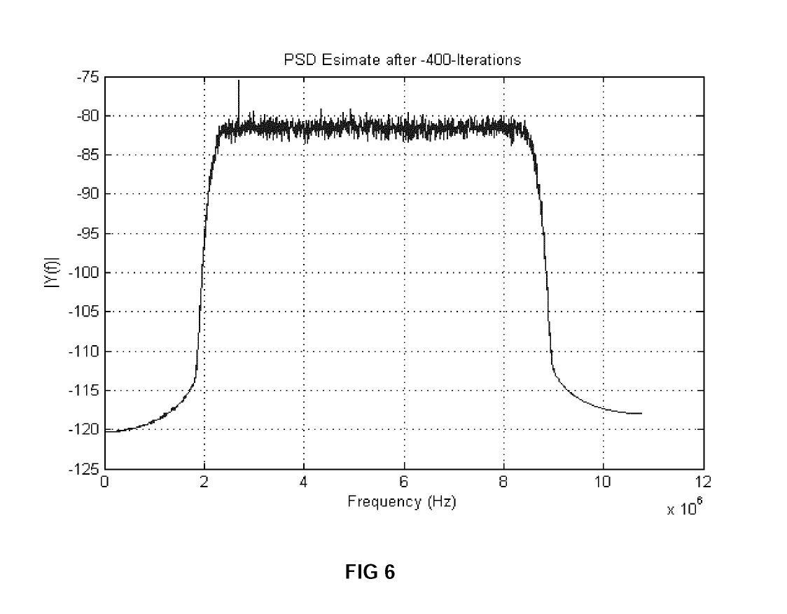

Example results for the above spectrum sensors and processes are now described. The results include Matlab simulations and laboratory tests mimicking the FCC sensing trials. FIG. 5 illustrates an estimated power spectrum (averaged over 400 Fast Fourier Transform (FFT) output) for a pure ATSC signal. FIG. 6 illustrates an estimated power spectrum (averaged over 400 FFT output) for an ATSC signal at −114 dBm with thermal noise. The process of ATSC pilot detection for ATSC signals discussed above relies on the pilot power level being significantly higher than the signal and noise level in the other parts of the channel Note that in FIG. 5 and FIG. 6, the power levels are modified in the sensor by multiple stages of amplifiers and AGCs, therefore the resulting power levels shown in the figures are different from that of the radio input.

For an ATSC signal at −114 dBm and an analog front end noise figure of 7 dB the signal-to-noise ratio (SNR) for the ATSC signal over a 6 MHz bandwidth is −14.8 dB. The pilot signal to noise floor ratio (or carrier-to-noise ratio, CNR) may be calculated as follows. For an example system with an FFT size N=1024 and sample rate of 82.031 kHz, the FFT resolution is 80.1 Hz/bin. The noise floor is thus −147.96 dBm/bin. As specified in the ATSC standard (Advanced Television systems Committee, Inc., “A/53: ATSC Digital Television Standard, Parts 1-6, 2007”), the pilot has a power 11.62 dB lower than the total power of the ATSC signal. Accordingly, the pilot level is −125.62 dBm (−114 dBm-11.62 dBm). Thus the pilot CNR is 22.34 dB (−125.62 dBm+147.96 dBm. Therefore, even when the SNR over the 6 MHz bandwidth is −14.8 dB, the disclosed systems and methods can achieve a pilot CNR of 22.34 dB for a received ATSC signal level of −114 dBm and detect the ATSC signal reliably.

Example SNR levels for WM signal detection are as follows. For a WM signal level −107 dBm, a WM designated bandwidth of 6 MHz, and an analog front end noise figure of 7 dB, the SNR for sensing measured over a 200 kHz band is 6.99 dB.

The foregoing ATSC pilot CNR and WM SNR values are calculated for a clean ATSC signal level of −114 dBm and a clean WM signal level of −107 dBm at the sensing receiver input. The pilot CNR and WM SNR may be reduced, for example, by signals from an adjacent channel leaking into the channel being sensed.

For both ATSC and WM signal detection, three types of test scenarios were used for the validation of the spectrum sensor design. The first test type is to determine the detection sensitivity of the scanning and sensing capability of the sensor on an undistorted (clean) ATSC or WM signal. Signals are generated and attenuated to desired power levels and input to the spectrum sensor and evaluation. The second test type is to test the spectrum sensor on multipath and fading distorted signals. Input signals to the sensor are either generated by signal generators and multipath simulators or captured off-the-air (such as the A/74 RF captures used in FCC testing). The third test type is to test the sensitivity of the spectrum sensor with the presence of adjacent channel interference. Signal generators and attenuators are used to generate both the signal to be sensed and the interference on the adjacent channel.

Results are shown in Table 1 below for the case where there is no adjacent channel interference. Here, P_{d} is the probability of detection, P_{f} is the probability of false alarm. As shown in the figure, the spectrum sensor design can achieve FCC requirements for both ATSC and WM signal detection.

TABLE 1
Minimum detectable signal level (sensitivity)
with P_{d} ≧ 0.9 and P_{f} ≦ 0.1

| | Sensitivity (dBm) | | FCC |
|---|---|---|---|
| Signal type | Simulation | Lab testing | requirement |
| ATSC | −120 | −116 | −114 |
| Wireless microphone | −114 | −110 | −107 |

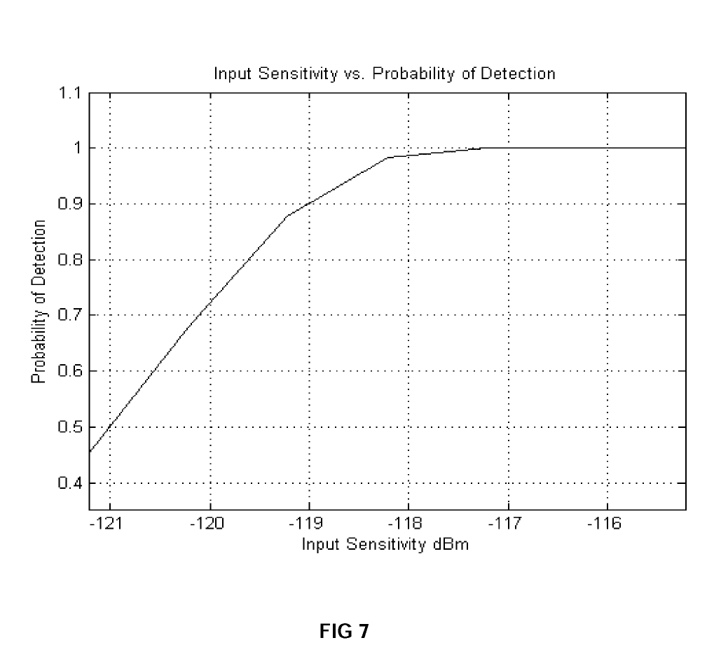

FIG. 7 illustrates the spectrum sensor performance, of an embodiment, for wireless microphone signal detection based on power spectrum thresholding. To illustrate the effectiveness of the detection processes, a simulation result is shown in FIG. 7. The simulated WM signal is a Soft Speaker Model presented by Shure. It has a modulation tone frequency of 3.9 kHz and a frequency deviation of 15 kHz. The simulation uses a front end noise figure of 7 dB. FIG. 7 shows, for example, the simulated performance for WM detection based on power spectrum thresholding (P₁=0.01).

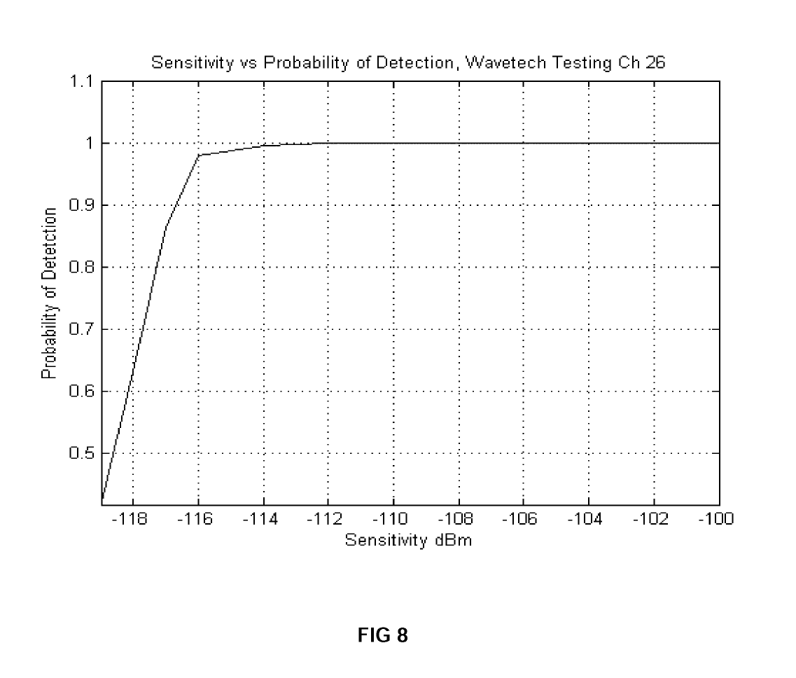

FIG. 8 illustrates the spectrum sensor performance, of an embodiment, for ATSC detection. To illustrate performance of another spectrum sensor, a lab testing result is shown in FIG. 8, which also illustrates the probably of detection under different ATSC signal levels with a P_{f}=0.01. Also, as can be seen from FIG. 8, the spectrum sensor can reliably detect ATSC signals at −116 dBm. T illustrated performance is for an ATSC signal on channel 26. FIG. 8 shows the P_{d} versus signal level curve, with P_{f}=0.01. As can be seen, when the ATSC signal is above the −114 dBm threshold, P_{d}≧0.99. The high P_{d} and low P_{f} values indicate that the sensor performance is good.

The above results show that the disclosed spectrum sensors can achieve and exceed the 2010 FCC requirements for both ATSC and WM detection in the case that no adjacent channel interference is present. Efforts may be ongoing to improve sensing performance for the case where there is adjacent channel interference. Spectrum sensing is an important method to ensure the protection of licensed services in the TVWS. The TVWS spectrum sensor therefore demonstrates detection capabilities that exceed and surpass FCC requirements.

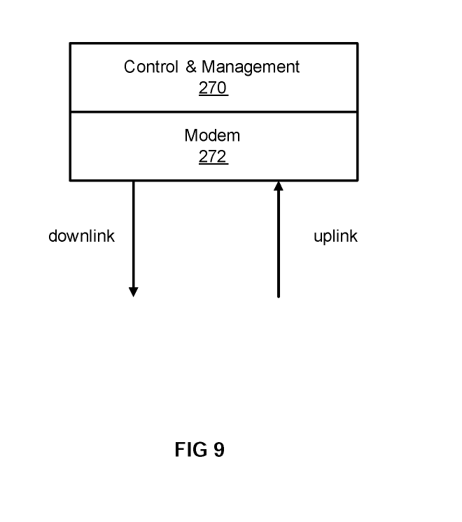

FIG. 9 illustrates a high level block diagram of an access point, for example, for WiFi service, or base station, according to an embodiment of the present disclosure. The corresponding elements of the base station shown in FIG. 9 can be used to implement the functionality of the above described radio, baseband processor, and the control and user interface, or the above described radio, baseband processor, and the control and user interface can be added to existing base station (or access points) architectures for the selection of transmission channels. The base station includes a modem section 272 which transmits and receives wireless signals. The modem can also measure and determine various characteristics of the received signals. The control and management section 270 was generally responsible for the operation of the base station. In some embodiments described herein, the control and management section 270 implements the system and method described above in the present disclosure. Similarly, the spectrum sensor and systems and methods associated with the spectrum sensor can be implemented in, for example, notebook and tablet computers, smart phones, personal data assistants, and other mobile devices.

Those of skill will appreciate that the various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the design constraints imposed on the overall system. Skilled persons can implement the described functionality in varying ways for each particular application, but such implementation decisions should not be interpreted as causing a departure from the scope of the invention. In addition, the grouping of functions within a module, block, or step is for ease of description. Specific functions or steps can be moved from one module or block without departing from the invention.

The various illustrative logical blocks and modules described in connection with the embodiments disclosed herein can be implemented or performed with a general purpose processor, a digital signal processor (DSP), application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such that the processor can read information from, and write information to, the storage medium. In the alternative, the storage medium can be integral to the processor. The processor and the storage medium can reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

What is claimed is:

1. A system for sensing TV-spectrum white space, the system comprising:
a radio module arranged for receiving a radio-frequency signal and producing an intermediate-frequency signal according to the radio-frequency signal received in a selected television channel; and
a baseband processor module coupled to the radio module and arranged for detecting the presence of an incumbent signal in the intermediate-frequency signal.

2. The system of claim 1, wherein the radio module comprises:
a plurality of radio frequency matching networks, each of the radio frequency matching networks coupled to an antenna and tunable to a range of television spectrum channels to produce a radio-frequency signal at a selected television spectrum channel;
a plurality of amplifiers coupled to the radio-frequency matching networks, each of the amplifiers arranged for providing an amplified version of the radio-frequency signal for the corresponding radio frequency matching network; and
a tuner network coupled to the plurality of amplifiers and arranged for producing the intermediate-frequency signal according to a selected one of the amplified radio-frequency signals from the plurality of amplifiers.

3. The system of claim 2, wherein the tuner network comprises automatic gain control.

4. The system of claim 3, wherein the tuner network further comprises a bandpass filter arranged for filtering the intermediate-frequency signal to the bandwidth of the television channel.

5. The system of claim 2, wherein the tunable ranges of the plurality of radio frequency matching networks are overlapping.

6. The system of claim 1, wherein the baseband processor module comprises:
an analog-to-digital converter arranged for digitizing the intermediate-frequency signal to produce digital samples;
a bandpass filter module arranged for bandpass filtering the digital samples;
a mixer arranged for downconverting the digital samples to produce a low intermediate-frequency signal; and
a Fourier transform module for converting the low intermediate-frequency signal to frequency domain data.

7. The system of claim 6, wherein downconverting by mixer operates to shift the frequency of an ATSC pilot signal to baseband.

8. The system of claim 6, wherein the baseband processor module further comprises:
a decimator module for downsampling the low intermediate-frequency signal before conversion to the frequency domain data.

9. The system of claim 8, wherein the baseband processor module further comprises:
an Advanced Television Systems Committee (ATSC) sensing module for detecting ATSC signals in the frequency domain data.

10. The system of claim 9, wherein the baseband processor module further comprises:
a wireless microphone sensing module for detecting WM signals in the frequency domain data.

11. The system of claim 1, wherein the baseband processor module comprises:
an analog-to-digital converter arranged for digitizing the intermediate-frequency signal to produce digital samples;
a bandpass filter module arranged for bandpass filtering the digital samples;
a mixer arranged for downconverting the digital samples to produce a low intermediate-frequency signal, the low intermediate-frequency signal having an expected ATSC pilot signal at zero frequency;
a first decimator module for downsampling the low intermediate-frequency signal;
a first Fourier transform module for converting the downsampled signal from the first decimator module to first frequency domain data;
a wireless microphone sensing module for detecting WM signals using the first frequency domain data;
a second decimator module for further downsampling the downsampled signal from the first decimator module;
a second Fourier transform module for converting the downsampled signal from the second decimator module to second frequency domain data; and
an Advanced Television Systems Committee (ATSC) sensing module for detecting ATSC signals using the second frequency domain data.

12. The system of claim 1, wherein the baseband processor module detects the presence of an incumbent signal of an Advanced Television Systems Committee type using a peak pilot to mean noise ratio.

13. The system of claim 1, wherein the baseband processor module detects the presence of an incumbent signal of a wireless microphone type using power spectrum thresholding.

14. A method for sensing an Advanced Television Systems Committee (ATSC) signal, the method comprising:
receiving a radio frequency signal;
digitizing a selected television channel from the received radio frequency signal to produce digital data;
converting the digital data to frequency domain data;
determining the maximum power in the frequency domain data at frequencies in a first window, the first window including frequencies near the pilot signal of an ATSC signal;
determining the average power in the frequency domain data at frequencies in a second window, the second window excluding frequencies near the frequency having the maximum power in the first window; and
detecting the presence of an ATSC signal based on the ratio of the maximum power in the frequency domain data at frequencies in the first window to the average power in the frequency domain data at frequencies in the second window.

15. The method of claim 14, further comprising smoothing the frequency domain data by averaging.

16. The method of claim 14, further comprising: downconverting the received radio frequency signal to an intermediate frequency before digitizing to produce the digital data.

17. The method of claim 14, further comprising downconverting the digital data before converting the digital data to frequency domain data, the downconverting operating to shift a ATSC pilot signal to baseband.

18. The method of claim 17, further comprising downsampling the downconverted digital data before converting the digital data to frequency domain data.

19. The method of claim 14, wherein determining the average power in the frequency domain data at frequencies in the second window comprises excluding the frequency domain data at frequencies in the second window that are greater than a first threshold or less than a second threshold.

20. A method for sensing a wireless microphone signal, the method comprising:
receiving a radio frequency signal;
digitizing a selected television channel from the received radio frequency signal to produce digital data;
converting the digital data to frequency domain data;
smoothing the frequency domain data by averaging;
estimating a noise level in the radio frequency signal using the smoothed frequency domain data;
determining average powers for the smoothed frequency domain data in a plurality of frequency windows, the frequency windows having a same bandwidth with different starting frequencies; and
detecting the presence of a wireless microphone signal based on the number of average powers greater than a threshold for consecutive starting frequencies, the threshold being based on the noise level.

21. The method of claim 20, wherein estimating the noise level comprises:
histogramming power levels of the smoothed frequency domain data for a band of frequencies; and
taking the power level of the maximum histogram bin as the noise level.

22. The method of claim 20, wherein the bandwidth of the frequency windows is less than the designated bandwidth of the wireless microphone signal.
